(19) United States
(12) Patent Application Publication
(10) Pub. No.: US 2012/0204524 A1
(43) Pub. Date: Aug. 16, 2012

(54) VACUUM CLEANER BAG

(75) Inventor: Wolfgang Czado, Porta Westfalica (DE)

(73) Assignee: WOLF PVG GMBH & CO. KG, Vlotho (DE)

(21) Appl. No.: 13/397,112

(22) Filed: Feb. 15, 2012

(30) Foreign Application Priority Data
Feb. 15, 2011 (DE) 202011000339.6

(51) Int. Cl. B01D 46/02

(52) U.S. Cl. 55/368

(57) ABSTRACT

A vacuum cleaner bag includes an outside wall composed of filter material, having with an inflow opening formed therein and a shape to define a closed interior space except for the inflow opening. A tube structure is disposed within the interior space of the outside wall and comprises an air-permeable material having a flow-through opening in a center region aligned with the inflow opening.

### CROSS-REFERENCE TO RELATED APPLICATION

This application claims the priority of the German Utility Model Patent Application No. 20 2011 000 338.6, filed on Feb. 15, 2011, the subject matter of which is incorporated herein by reference.

### BACKGROUND OF THE INVENTION

The present invention relates to a vacuum cleaner bag comprising an outside wall of a filter material with an inflow opening formed therein.

U.S. Pat. No. 3,370,405 discloses a vacuum cleaner bag for which a separating wall is glued along opposite-arranged longitudinal sides to an outside wall of the vacuum cleaner bag. As a result, the inside space of the vacuum cleaner bag is divided into two chambers through which air flows at least in part successively. Both chambers, however, are surrounded by the outside wall of the vacuum cleaner bag, so that only a limited separation into a pre-filter and a subsequent filter takes place and the separating wall consequently does not noticeably increase the service life of the vacuum cleaner bag.

German patent document DE 20 2006 016 3030 discloses a vacuum cleaner bag provided with an additional bag on the inside, wherein the opening for the additional bag is arranged to fit around the inflow opening of the vacuum cleaner bag. As a result, the air flowing in can first be pre-filtered in the smaller bag and can subsequently be filtered once more while flowing through the outside wall of the vacuum cleaner bag. One disadvantage, however, is that the inside bag has a relatively small volume and therefore fills up quickly. Inserting a bag of this type into the vacuum cleaner bag is furthermore difficult from a production technical point of view, wherein the production of the inside bag is additionally quite involved. In addition, problems can occur with the unfolding of the vacuum cleaner bag during the operation if the air does not flow evenly through the inside bag.

### SUMMARY OF THE INVENTION

It is therefore an object of the present invention to create a vacuum cleaner bag having a longer service life while still maintaining a high suction capacity, even while increasingly filling with dust. In addition, it should be possible to achieve an effective filtering.

The above and other objects are accomplished according to the invention by the provision of a vacuum filter bag, which in one embodiment, comprises: an outside wall comprised of filter material, having an inflow opening formed therein and a shape to define a closed inside space except for the inflow opening; and a tube structure disposed within the inside space of the outside wall and comprised of an air-permeable material having a flow-through opening in a center region aligned with the inflow opening.

As a result, the air entering through the inflow opening moves through the flow-through opening and thus into the tube structure where a pre-filtering can take place, wherein the inflowing air is divided into two partial flows as a result of the shape of the tube structure. Owing to the tube structure, the airflow can be pre-filtered so that air flowing out of the tube structure contains only a portion of the dust, in particular smaller particles. The pre-filtered residual dust can then be filtered once more by the outside wall of the vacuum cleaner bag, wherein a clogging of the outside wall of the vacuum cleaner bag occurs at a noticeably later point in time since a large share of the dust has already been trapped in the tube structure.

According to one embodiment, the tube structure is attached at least in part to the outside wall. This attachment is intended to guarantee that the through opening is positioned opposite the inflow opening, so as to ensure a pre-filtering inside the tube structure.

The tube structure advantageously should only occupy a portion of the inside volume of the vacuum cleaner bag, in particular ranging from 10% to 50%, and more particularly ranging from 15% to 30%. As a result, it is ensured that the tube structure is located at a certain distance to the outside wall of the filter material which allows an effective filtering in two chambers. In the expanded state of the vacuum cleaner bag, the tube structure may be arranged over at least 60%, preferably at least 80%, of its circumferential surface at a distance to the outside wall of the vacuum cleaner bag. Thus, it is ensured that the air flows initially through the wall of the tube structure and subsequently flows through the outside wall of the vacuum cleaner bag.

The tube structure can be closed off on at least one side, wherein the tube structure is may also be closed on opposite sides and is attached, for example, to a seam on the outside wall. The tube structure can substantially extend over the complete length of the vacuum cleaner bag, so that it can be supplied in the form of a web or tube during the production.

According to a different embodiment of the invention, the flow-through opening may be surrounded by an edge which is stiffer than the remaining material of the tube structure, thereby preventing damage to the edge of the flow-through opening even at high speeds, e.g. damage in the form of cracks or deformations. The edge can be stiffened by reinforcing it with a non-woven material or with the aid of different measures.

The tube structure advantageously consists of a material having a higher air-permeability than the outside wall of the vacuum cleaner bag. For example, the tube structure can be produced from a non-woven material, in particular a carded nonwoven. However, other materials can also be used such as fabric, a perforated foil, paper, cardboard, a lattice-type material, a netting material or a combination of these materials. The air-permeability of the tube structure may reach more than 600 l/m²s, and even greater than 1000 l/m²s.

According to a further embodiment of the invention, the tube structure is attached at least at one location to an inside wall, in part while folded up so as to reduce the diameter. The fold can be formed in that the tube structure is held together along the edge of one inside wall with the aid of adhesive or a welded seam, so that only a reduced expansion of the tube structure is possible in the region. As a result, the shape of the tube structure can be adapted, for example by adapting it to a vacuum cleaner chamber which is embodied flatter in a specific region. The functionality of the tube structure can thus be maintained even in this region.

With the aid of a holding mechanism, the flow-through opening is kept in place adjacent to the inflow opening. An adhesive or welded seam or also a piece of material can serve as holding mechanism, such as the material piece which can remain after stamping out the flow-through opening and which can still be connected at least partially to the tube structure. This material piece can then be used to secure the tube structure at a distance to the outside wall. Regardless of the type of holding mechanism which is used to secure the tube structure and thus the flow-through opening in the outside wall of the vacuum cleaner bag, the holding mechanism can form a predetermined breaking point which separates when a breaking force is exceeded. Once the tube structure is filled and can no longer function as pre-filter, it is advantageous if the tube structure is removed from the secured position and is deposited on the inside of the vacuum cleaner bag. In that case, the inflowing air can be filtered directly by the outside wall of the vacuum cleaner bag until the vacuum cleaner bag is completely filled. The breaking force at the predetermined breaking point in that case can range from 2 to 20N, and more particularly from 5 to 10N.

The tube structure is advantageously connected to the outside wall with the aid of at least one adhesive or welded strip that is oriented in a longitudinal direction of the tube structure. However, it is also possible to provide at least one adhesive or welding strip on each of the opposite sides of the flow-through opening for securing the flow-through opening relative to the inflow opening. As a result of the connection via an adhesive or welding strip, oriented in the longitudinal direction, only a minimum surface area of the tube structure is secured to the outside wall of the vacuum cleaner bag, thus keeping to a minimum the loss in the filtering surface at the connecting location.

The vacuum cleaner bag is advantageously embodied as a flat bag, comprising a top layer of filter material and a bottom layer of filter material which layers are welded together circumferentially along the edges. The vacuum cleaner bag can furthermore to be provided with a side fold along one or two opposite-arranged sides which fold extends parallel to the longitudinal direction of the tube structure, thereby making it easier to unfold the vacuum cleaner bag once it is inserted into a chamber of the vacuum cleaner. However, the vacuum cleaner bag can also be embodied as a bag with a block-shaped bottom or can be embodied with a different geometry.

### BRIEF DESCRIPTION OF THE DRAWINGS

These and other features of the invention will be further understood from the following detailed description with reference to the accompanying drawings, which show in:

FIG. 1 shows a view of a vacuum cleaner bag of the invention, as seen from the outside;

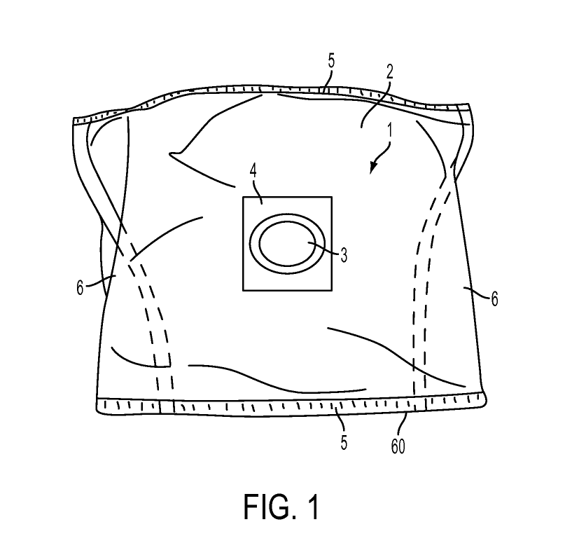

FIG. 2 shows a view of the vacuum cleaner bag according to FIG. 1 during production; and

FIG. 3 shows a view of the vacuum cleaner bag illustrated in FIG. 1, without the top layer of filter material.

### DETAILED DESCRIPTION

A vacuum cleaner bag 1 comprises a top layer 2 of filter material with an inflow opening 3 formed therein, which is surrounded by a holding plate 4. A connecting piece of a vacuum cleaner can be inserted into this inflow opening 3. The top layer 2 is welded together circumferentially along the edges with a bottom layer 7 of filter material, so that a circumferential welding seam 5 is formed. To facilitate the unfolding of the vacuum cleaner bag 1 following the insertion into the chamber of a vacuum cleaner, side folds 6 are formed on two opposite-arranged sides of the vacuum cleaner bag 1, wherein one of these folds is attached on one side to the welded seam 5. A region with four layers is thus formed in one end section 60 of the welded seam 5, as a result of the top layer 2 being folded toward the inside and the bottom layer 7 being folded toward the inside. Of course, it is also possible to embody the side fold 6 by simply folding it and not securing it along a welded seam 5, or to secure the side fold 6 at both ends with a four-layer region 60 and welding together of this section 60.

The filter material used for the top layer 2 and the bottom layer 7 may comprise a multilayer nonwoven material, provided with at least one fine filter layer, for example a layer of meltblown.

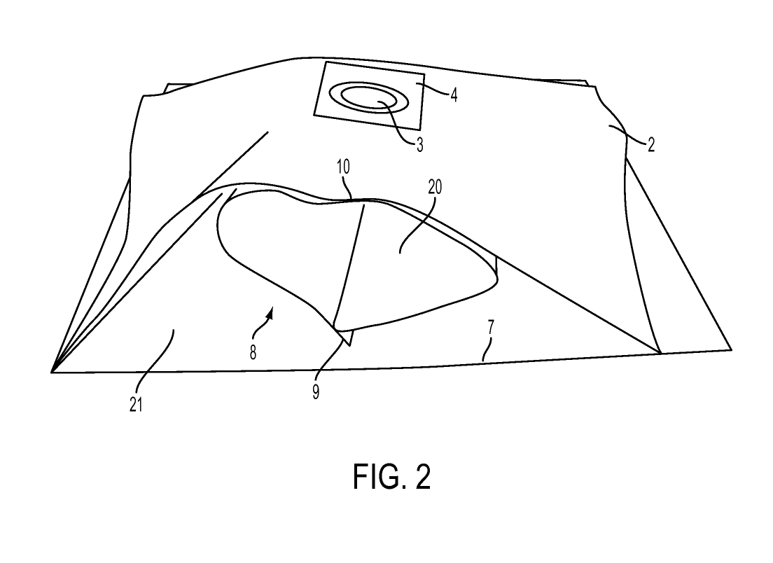

As shown in FIG. 2, the vacuum cleaner bag 1 comprises a tube structure 8 between the top layer 2 and the bottom layer 7, which form the outside wall of the vacuum cleaner bag 1. The tube structure 8 comprises an air-permeable material, in particular an air-permeable nonwoven material such as a carded nonwoven. However, the tube structure can also comprise an air-permeable foil or any other type of material which is suitable for pre-filtering the air flowing in. The tube structure 8 may be produced in that the opposite-arranged edges of a web are placed one on top of the other and glued and/or welded together, so that a longitudinal seam 9 is formed in a longitudinal direction of the tube structure 8. The tube structure 8 forms an inside chamber 20, wherein this inside chamber is separated from an inside space 21 of the vacuum cleaner bag 1 by the walls of the tube structure 8. Of course; it is also possible to provide one or several exit openings in the tube structure 8 to reduce the flow resistance of the tube structure 8.

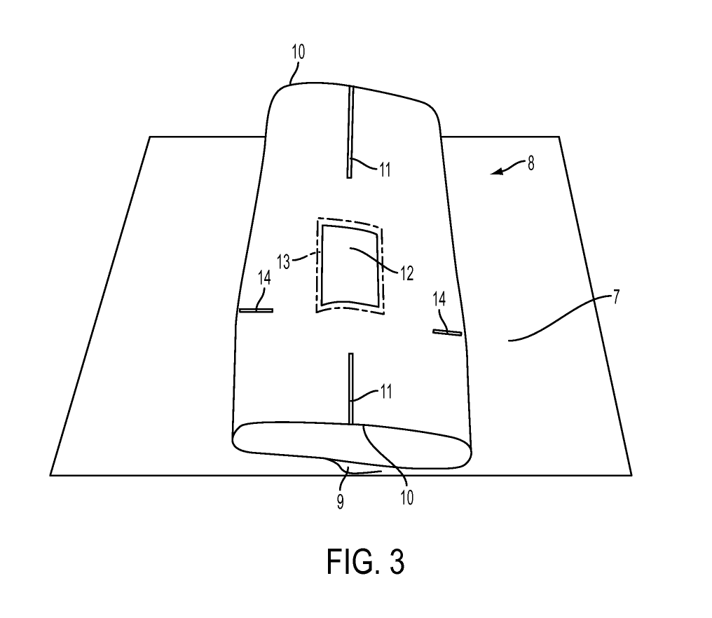

FIG. 3 shows the vacuum cleaner bag 1 without the top layer of filter material 2. Shown is only the bottom layer 7 of filter material with the tube structure 8 positioned thereon. However, the tube structure 8 is otherwise not connected to the bottom layer 7.

The tube structure 8 comprises a flow-through opening 12 which is surrounded by an edge 13 that is embodied stiffer than the remaining material of the tube structure 8. The edge 13 can be reinforced and/or stiffened through compacting of the nonwoven material, by applying an adhesive agent to the edge 13, or through welding it on. As a result, it is prevented that the edge 13 of the flow-through opening 12 is damaged by high air speeds.

To secure the tube structure 8 so that inside the vacuum cleaner bag 1 the flow-through opening 12 is arranged opposite the inflow opening 3, strip-type and/or line-type adhesive seams or welded seams 11 are provided which are aligned in a longitudinal direction of the tube structure 8. Respectively one adhesive seam 11 is provided on opposite sides of the through opening 12, wherein this seam ends at a distance to the edge 13 of the through opening 12. Attaching the tube structure 8 along a line to the top layer 2 has the advantage that only small areas are needed as connecting locations, so that the filtering losses are negligible.

The distance along the welding seam 5, between the flow-through opening 12 and the ends of the tube structure 8, preferably measures more than 20%, in particular more than 30%, of the length of the vacuum cleaner bag.

The tube structure 8 furthermore comprises connecting locations 14, arranged along the edge, for connecting the sections of the inside wall of the tube structure 8 to each other, thereby reducing the tube structure 8 in this region. The width of the connecting locations 14 can be selected based on the type of use, so as to reduce the expansion of the tube structure 8 in a specific region. For the exemplary embodiment shown herein, respectively one connecting location 14 for reducing the diameter is provided on opposite sides of the tube structure 8. However, several connecting locations 14 can also be provided over the length of the tube structure 8. The tube structure 8 can thus have a substantially oval geometry in place of a circular cross-sectional geometry for the tube structure 8.

The tube structure 8 is closed along opposite-arranged sides. The tube structure 8 thus has the same length as the layer 7 of filter material. The tube structure 8 is welded together at the opposite-arranged ends 10, preferably together with the seam 5 of the vacuum cleaner bag 1. The seam 5 in that case is embodied with four layers in the region of the tube structure 8.

For producing the vacuum cleaner bag 1, a tube structure 8 in the form of a web is initially placed onto the bottom layer 7 of filter material, which is also in the form of a web. This tube structure 8 already contains the through opening 12 and the edge 13 has been reinforced. Subsequently, the top layer 2 of filter material is supplied in the form of a web and secured via adhesive seams 11 or welded seams 11 to the tube structure 8. The top layer 2 and the bottom layer 7 are then welded together circumferentially along the edges and, if applicable one or several side folds 6 are formed as well.

For the exemplary embodiment shown herein, the through opening 12 is embodied rectangular while the inflow opening 3 is embodied circular. Of course, it is also possible to embody the through opening 12 circular or to make it somewhat larger than the inflow opening 3.

The tube structure 8 can furthermore be secured with the aid of a material piece to the top layer 2, for example with the material piece obtained when stamping out the through opening 12. The connecting location between the tube structure 8 and the top layer 2 in this case can be embodied as desired breaking point. With increased filling of the tube structure 8, the forces acting upon the connecting location also increase, thereby causing a break at the desired breaking point location once a predetermined breaking force is exceeded. The tube structure 8 is then no longer effective as a pre-filter, but also presents less of an obstacle to the entering flow of air. As a result, the service life of the vacuum cleaner bag 1 can be increased further.

It will be understood that the above description of the present invention is susceptible to various modifications, changes and adaptations, and the same are intended to be comprehended within the meaning and range of equivalents of the appended claims.

What is claimed is:

1. A vacuum cleaner bag, comprising:
an outside wall comprised of filter material, having an inflow opening formed therein and a shape to define a closed inside space except for the inflow opening; and
a tube structure disposed within the inside space of the outside wall and comprised of an air-permeable material having a flow-through opening in a center region aligned with the inflow opening.

2. The vacuum cleaner bag according to claim 1, wherein the tube structure is in part attached to the outside wall.

3. The vacuum cleaner bag according to claim 1, wherein the tube structure takes up a volume of between 10% and 50% of the inside space.

4. The vacuum cleaner bag according to claim 1, wherein the tube structure takes up a volume of between 25% and 30% of the inside space.

5. The vacuum cleaner bag according to claim 1, wherein the tube structure is arranged so that at least 60% of a circumferential surface of the tube structure is spaced apart from the outside wall when the vacuum cleaner bag is in an expanded state.

6. The vacuum cleaner bag according to claim 1, wherein the tube structure is arranged so that at least 80% of a circumferential surface of the tube structure is spaced apart from the outside wall when the vacuum cleaner bag is in an expanded state.

7. The vacuum cleaner bag according to claim 1, wherein the tube is closed off along at least one side.

8. The vacuum cleaner bag according to claim 7, wherein the outside wall has a seam and the tube structure has opposite sides attached to the seam.

9. The vacuum cleaner bag according to claim 1, wherein the tube structure extends essentially over a complete length of the vacuum cleaner bag.

10. The vacuum cleaner bag according to claim 1, wherein the tube structure has an edge surrounding the flow-through opening that is stiffer than remaining material for the tube structure.

11. The vacuum cleaner bag according to claim 1, wherein the tube structure comprises a material having a higher air-permeability than the filter material of the outside wall.

12. The vacuum cleaner bag according to claim 1, wherein the tube structure has an air-permeability of more than 600 l/m²s.

13. The vacuum cleaner bag according to claim 1, wherein the tube structure has an air-permeability of more than 1,000 l/m²s.

14. The vacuum cleaner bag according to claim 1, wherein the tube structure is attached in part to at least one location to an inside surface of the outside wall and has folds to reduce the diameter.

15. The vacuum cleaner bag according to claim 1, wherein the flow-through opening is kept in place adjacent to the inflow opening with the aid of a holding mechanism.

16. The vacuum cleaner bag according to claim 15, wherein the holding mechanism has a predetermined breaking point which separates once a breaking force is exceeded.

17. The vacuum cleaner bag according to claim 16, wherein the breaking force is in a range of 2 to 20N.

18. The vacuum cleaner bag according to claim 16, wherein the breaking force is in a range of 5 to 10N.

19. The vacuum cleaner bag according to claim 1, wherein the tube structure is connected to the outside wall via at least one adhesive or welded strip extending in a longitudinal direction of the tube structure.

20. The vacuum cleaner bag according to claim 1, wherein the outside wall of the filter bag includes a top layer of filter material and a bottom layer of filter material which are welded together circumferentially along the edges.

21. The vacuum cleaner bag according to claim 1, wherein the outside wall includes a side fold on at least one side of the vacuum cleaner bag which is oriented parallel to a longitudinal direction of the tube structure.
